(19) United States
(12) Patent Application Publication
(10) Pub. No.: US 2015/0285224 A1
(43) Pub. Date: Oct. 8, 2015

(54) COMPONENT ARRANGEMENT FOR A WIND TURBINE, METHOD OF ASSEMBLY AND OPERATING METHOD

(71) Applicant: Senvion SE, Hamburg (DE)

(72) Inventor: Ralf Hambrecht, Fockbek (DE)

(21) Appl. No.: 14/745,649

(22) Filed: Jun. 22, 2015

Related U.S. Application Data
(63) Continuation of application No. PCT/EP2013/003742, filed on Dec. 11, 2013.

(30) Foreign Application Priority Data
Dec. 27, 2012 (DE) 10 2012 224 423.9

(51) Int. Cl. F03D 11/00; G01L 1/18; F16C 41/00; G01L 1/16; F16C 19/28; F16C 43/04

(52) U.S. Cl. CPC F03D 11/0091; F16C 19/28; F16C 43/04; F16C 41/00; F03D 11/0008; G01L 1/16; G01L 1/18

(57) ABSTRACT

A component arrangement for a wind turbine including an outer component, an inner component arranged within the outer component, and a rolling bearing pair, which has a first rolling bearing and a second rolling bearing arranged in a manner adjusted relative to one another and which is preloaded by means of a clamping force. The inner component and the outer component are mounted so as to be rotatable relative to one another about an axis of rotation by means of the rolling bearing pair. The component arrangement also includes a pressure sensor for determining a preload of the rolling bearing pair, which is arranged in a flow of the clamping force. A method for assembling a component arrangement, a wind turbine having a component arrangement, and a method for operating a wind turbine is also disclosed.

### CROSS-REFERENCE TO RELATED APPLICATIONS

This application is a continuation of International Patent Application No. PCT/EP2013/003742, filed Dec. 11, 2013, and claims priority to German Patent Application No. DE 10 2012 224 423.9, filed Dec. 27, 2012.

### BACKGROUND OF INVENTION

1. Field of Invention

The invention relates to a component arrangement for a wind turbine comprising an outer component, an inner component arranged within the outer component, and a rolling bearing pair, which has a first rolling bearing and a second rolling bearing arranged in a manner adjusted relative to one another and which is preloaded by means of a clamping force, wherein the inner component and the outer component are mounted so as to be rotatable relative to one another about an axis of rotation by means of the rolling bearing pair. The invention also relates to a method for assembling a bearing arrangement of this type. The invention additionally relates to a wind turbine and a method for operating a wind turbine.

2. Brief Description of Related Art

In modern wind turbines adjusted bearings are used at various locations, for example as rotor bearing, as shaft bearing or as bearing for movable components within a transmission or a generator of the wind turbine.

An adjusted bearing generally comprises two rolling bearings, which support two components rotatable relative to one another radially, i.e. transversely to the axis of rotation, against one another. Axially, i.e. parallel to the axis of rotation, the two rolling bearings are preloaded against one another. Adjusted bearings have the advantage that they can take up radial forces, axial forces and tilting moments, and in so doing are free of play axially.

The correct preload of the bearing is of particular importance for the functional capability and service life of an adjusted bearing. If the preload is too weak, there is the risk that the rolling bearings or the rolling bearing set will slip and that slip damage could be sustained, and that the bearing is no longer free of play under load and as a result in particular the rolling bearings will be loaded in a non-uniform manner, which leads to excessively strong peak loads. If the preload is too strong, the rolling bearings will also be excessively loaded. In both cases the functionality of the bearing will be impaired and the mechanical efficacy of the wind turbine will be reduced, for example as a result of increased bearing friction. At the same time, the service life of the bearing will be significantly reduced, in particular as a result of increased wear.

In order to avoid consequential damage caused by damaged bearings, modern wind turbines often have monitoring systems that can identify bearing damage, for example on the basis of increased vibrations. Abnormal bearings are generally replaced in good time, however this is regularly associated with considerable cost and involves downtimes of the wind turbine with corresponding loss of profit. It has been found in practice that the calculated service life of a bearing often is not reached in this case.

Proceeding from this prior art, the object of the invention is to improve the service life of an adjusted bearing of a wind turbine and to avoid the losses of income of the wind turbine on account of limited functionality of the adjusted bearing.

### BRIEF SUMMARY OF THE INVENTION

This object is achieved in accordance with the invention by a component arrangement for a wind turbine comprising an outer component, an inner component arranged within the outer component, and a rolling bearing pair, which has a first rolling bearing and a second rolling bearing arranged in a manner adjusted relative to one another and which is preloaded by means of a clamping force, wherein the inner component and the outer component are mounted so as to be rotatable relative to one another about an axis of rotation by means of the rolling bearing pair, wherein the component arrangement according to the invention also comprises a pressure sensor for determining a preload of the rolling bearing pair, said pressure sensor being arranged in a flow of the clamping force.

It is in particular an advantage of the invention that one of the primary causes of bearing damage, specifically an incorrect preload, in particular an excessively high or excessively low preload, can be identified already before the occurrence of bearing damage with noticeable effects, for example reduced smoothness, increased vibration and noise emission, or increased heat development in the bearing. A correction or adaptation of the preload, in particular by appropriate modification of the clamping force, is thus made possible before damage occurs at the bearing, in particular at the rolling bearings. The optimal functionality of the bearing formed by means of the rolling bearings is thus ensured, the service life of the rolling bearings is improved, and a reduction in profits of a wind turbine as a result of limited functionality of the bearing as a whole or of the rolling bearings individually is thus avoided.

A component in the sense of the invention can be formed in one piece or can comprise a number of sub-components connected to one another detachably or non-detachably.

A rolling bearing in the sense of the invention in particular has two concentric bearing surfaces facing one another, between which rolling bearings are arranged. The rolling bearings for example are spherical, conical, cylindrical, needle-shaped or barrel-shaped and roll over the bearing surfaces as the bearing surfaces are rotated relative to one another. The bearing surfaces can be formed in portions in a manner complementary to the shape of the rolling bearings in order to achieve a greater contact area between rolling bearings and bearing surface and therefore a higher load-bearing capability of the rolling bearing.

A rolling bearing also comprises, by way of example, an inner ring, on the outer periphery of which the inner of the two bearing surfaces is formed and which is connected or can be connected to the inner component. Alternatively the inner bearing surface is formed on a surface of the inner component, in particular facing radially outwardly.

A rolling bearing additionally comprises, by way of example, an outer ring, on the inner periphery of which the outer of the two bearing surfaces is formed and which is connected or can be connected to the outer component. Alternatively the outer bearing surface is formed on a surface of the outer component, in particular facing radially inwardly.

A rolling bearing of the component arrangement according to the invention is in particular designed to take up or to support radial loads and axial loads in at least one direction. Rolling bearings of this type are, for example, angular-contact ball bearings, tapered-roller bearings, 4-point bearings, spherical roller bearings, barrel roller bearings, ball roller bearings, angular-contact cylinder roller bearings, or cylinder roller bearings or deep-groove ball bearings with primary pressure angle in the radial or also in the axial direction, known in the prior art.

Within the scope of the invention the specifications axial and radial each relate to the axis of rotation of the components mounted or to be mounted rotatably relative to one another, wherein in particular a direction along the axis of rotation is referred to as axial and a direction transversely to the axis of rotation is referred to as radial.

In accordance with the invention the rolling bearings are arranged in a manner adjusted relative to one another. This is understood to mean in particular that the two rolling bearings of the component arrangement can each take up or support forces or moments in opposite axial direction, such that the components of the component arrangement can be mounted or are mounted free of play axially by the rolling bearing pair.

The rolling bearing pair is preloaded in accordance with the invention by means of a clamping force, wherein a clamping force in the sense of the invention in particular is a compressive force, which can be applied to or is applied to the rolling bearing pair or the rolling bearings individually, in particular in the axial direction.

A flow of the pumping force is understood within the scope of the invention to mean in particular the distribution, support or diversion of the clamping force within the component arrangement. Radial components of the flow of force here mostly compensate for one another, for example by axially symmetrical construction of the rolling bearings. Axial components of the flow of force are diverted or supported by at least one tensile loaded component of the component arrangement, which in particular is the inner component or the outer component.

The clamping force in particular causes a preload of the rolling bearing pair. This is understood within the scope of the invention in particular to mean that the rolling bearings of the rolling bearing pair are pressed together by means of the clamping force in such a way that each of the rolling bearings has an undersize or an overall height reduction or overall height compression.

A preload of the rolling bearing pair caused by the clamping force is determined in accordance with the invention by means of a pressure sensor, which is arranged within the flow of the clamping force, for example at the transition between a rolling bearing and a component or within a rolling bearing.

The clamping force is predefined for example during the assembly of a component arrangement according to the invention and is adjusted repeatedly to an optimal value with determination of the preload by means of the pressure sensor.

The component arrangement preferably comprises, for preloading the rolling bearing pair by means of a predefinable clamping force, a first clamping device acting on the first rolling bearing and/or a second clamping device acting on the second rolling bearing.

A clamping device in particular has a stop for a rolling bearing, which stop is displaceable in the axial direction and is fastened or can be fastened in particular detachably to the first component or the second component.

A stop displaceable axially or in the axial direction is provided for example with use of suitable screw connections, inserted gauge plates of adapted thickness, hydraulically or pneumatically spreadable spacer rings, hydraulically preloadable shaft nuts, or bolts fixed in predetermined position by transverse press-fit connection. In particular, a simple modification or adaptation of the clamping force is enabled hereby.

If merely one clamping device is provided, the rolling bearing pair is preloaded from one side. This generally results, with a modification of the clamping force, in an axial displacement of the inner component and of the outer component relative to one another, which may be undesirable in the individual case.

If, by contrast, two clamping devices are provided, the rolling bearing pair is preloaded in particular from both sides. An axial adjustment or orientation of the inner component and of the outer component relative to one another with simultaneous adaptation of the clamping force is thus made possible advantageously.

It is also preferable when the pressure sensor is arranged on a side of a rolling bearing facing away from a clamping device. As a result, when establishing or determining the clamping force, any preload loss occurring between the clamping device and the pressure sensor, for example on account of friction or plastic deformation within the flow of clamping force, is advantageously taken into consideration. A greater accuracy when establishing the preload is thus achieved.

When merely one clamping device is provided on one of the two rolling bearings, the pressure sensor is preferably arranged on the other of the two rolling bearings, in particular on the side facing away from the rolling bearing having the clamping device. Optimal accuracy when determining a mean preload of both rolling bearings is achieved in this way.

A particularly preferred pressure sensor is formed as a thin-film sensor, in particular having a piezo-electric or piezo-resistive sensor layer. Known thin-film sensors generally have thicknesses of less than one millimeter up to a few micrometers, wherein the thickness is independent of a pressure to be determined by means of the sensor or is only dependent thereon to a very small extent.

This results in particular in the advantage that the pressure sensor arranged in the flow of clamping force does not significantly influence the axial extension of the bearing arrangement and thus the clamping force. In addition, the axial orientation of the mounted components relative to one another is not influenced by the pressure sensor.

A further advantage of a thin-film sensor lies in the fact that sensors of this type can be used in a very versatile manner. By way of example it is possible to apply the sensor layer directly to a component, for example to a functional surface, in particular a bearing surface or contact surface, of a bearing ring within a rolling bearing. Integrated thin-film sensors of this type then allow the direct measurement of a clamping force present within a rolling bearing.

Alternatively, the thin-film sensor is formed as an independent component, in particular with a layer carrier for the sensor layer independent of the other constituent parts of the component arrangement.

Suitable layer carriers are, for example, films or thin plates made of plastic, metal or ceramic.

Thin-film sensors formed as independent components are in particular much more economical than integrated thin-film sensors and can be replaced easily and economically in the case of defects.

In a preferred development of the invention the component arrangement has an evaluation device for evaluating measurement signals of the pressure sensor.

In particular, an automatic and/or regular determination of the clamping force is thus made possible, in particular also during running operation of the wind turbine.

Additionally or alternatively the component arrangement for example has a connector for connection of the pressure sensor to an external evaluation device for evaluation of measurement signals of the pressure sensor. A single evaluation device is thus available for a number of component arrangements or pressure sensors thereof.

The accuracy when determining the preload of the two rolling bearings is further increased in that the component arrangement according to the invention has at least a first pressure sensor arranged at the first rolling bearing and a second pressure sensor arranged at the second rolling bearing. A separate determination of the preload of the first rolling bearing and the preload of the second rolling bearing is thus made possible.

In addition, a two-way function check is ensured with a first pressure sensor and a second pressure sensor, and an increased safeguarding against failure is provided because, even in the event of a defect of one of the two pressure sensors, a preload can still be established or determined for both rolling bearings by means of the other pressure sensor.

The invention also includes embodiments with further pressure sensors, wherein for example a pressure sensor is arranged on both sides of each of the two rolling bearings.

The component arrangement preferably comprises at least three pressure sensors, which in particular are arranged in a plane oriented transversely to the axis of rotation. By way of example, the at least three pressure sensors are arranged along a circle about the axis of rotation at equal distance from one another.

Besides the preload, a radial asymmetry of the preload can thus also be determined and therefore compensated for suitably.

An asymmetry of the preload, which for example can be caused by non-uniform tightening of the fastening screws of a bearing cover, leads to a non-uniform loading of the rolling bearings, whereby the rolling bearings may each have areas along their periphery with excessively high preload and/or areas with excessively low preload, even when the preload averaged over the periphery corresponds to the corresponding setting. As with a preload that as a whole is incorrect, the likelihood of damage at the rolling bearings potentially leading to premature failure rises also with an asymmetry of the preload.

An asymmetrical preload is produced for example on account of a radial loading of the component arrangement when the rolling bearings are not oriented exactly parallel to one another and/or are not oriented exactly concentrically about the axis of rotation, or when the clamping force has a radial asymmetry. Conversely, it is possible to compensate for a radial asymmetry of the preload by means of a suitably selected asymmetry of the clamping force.

The component arrangement is preferably formed as a constituent part for a power train of the wind turbine, in particular as a rotor bearing, as a transmission, as a generator, or as part of a rotor bearing, part of a transmission, or part of a generator.

By way of example, the inner component is a rotor shaft and the outer component is a mount for a rotor of the wind turbine driving the rotor shaft.

The inner component and/or the outer component of the component arrangement may also each be a constituent part of a transmission or of a generator of the wind turbine.

The object forming the basis of the invention is also achieved by a method for assembling a component arrangement according to the invention, said method having the following method steps:
calibrating at least one pressure sensor of the component arrangement,
preloading the rolling bearing pair of the component arrangement with a predefinable clamping force,
determining an actual value for a preload of the rolling bearing pair by means of the at least one pressure sensor,
comparing the actual value with a predefined tolerance range around a predefined target value for the preload, and
where appropriate, adapting the clamping force when the actual value lies outside the tolerance range.

The target value for the preload is in particular predefined on the basis of an optimal preload under consideration of an anticipated loading of the rolling bearing pair during operation.

The tolerance range is predefined in particular on the basis of the acceptable assembly tolerances and specifies the admissible symmetric or asymmetric deviation of the actual value from the target value in the peripheral direction.

If the established actual value for the preload lies outside the tolerance range, the clamping force is adapted in accordance with the invention. This means in particular that the clamping force with which the rolling bearing pair is preloaded is increased if the actual value is below the target value, in particular below a lower limit of the tolerance range, and that the clamping force is reduced if the actual value is greater than the target value, in particular greater than an upper limit of the tolerance range.

The at least one pressure sensor is calibrated in accordance with the invention in order to determine the actual value in a sufficiently accurate manner.

The pressure sensor is preferably calibrated in an assembly position of the component arrangement with vertically arranged axis of rotation without application of a clamping force with utilization of a known mass of the inner component and/or the outer component and/or of one of the two rolling bearings and/or both rolling bearings.

In the assembly position with vertically arranged or oriented axis of rotation, the pressure sensor is loaded in particular by the weight force of the inner component and/or the outer component and/or of the rolling bearings, provided these are arranged in the assembly position above the pressure sensor and rest directly or indirectly on the pressure sensor. The force acting on the pressure sensor is given here directly from the known masses of the components resting on the pressure sensor, such that a very accurately known a calibration point is provided.

If a number of components rest above one another on the pressure sensor, a number of calibration points are given accordingly by adding the individual components incrementally, such that even non-linear pressure sensors can be calibrated accordingly. In addition, a zero-point calibration of the pressure sensor is provided before adding the first or, based on the assembly position, lowermost component, i.e. provided the pressure sensor is still unloaded.

The object forming the basis of the invention is also achieved by a wind turbine having a component arrangement, wherein the component arrangement has an outer component, an inner component arranged within the outer component, and a rolling bearing pair, which has a first rolling bearing and a second rolling bearing arranged in a manner adjusted relative to one another and which is preloaded by means of a clamping force, wherein the inner component and the outer component are mounted so as to be rotatable relative to one another about an axis of rotation by means of the rolling bearing pair, wherein the component arrangement according to the invention is further developed in that the component arrangement also comprises a pressure sensor for determining a preload of the rolling bearing pair, said pressure sensor being arranged in a flow of the clamping force. The component arrangement is in particular a previously described component arrangement according to the invention.

A particularly preferred wind turbine comprises a plurality of component arrangements according to the invention. In particular, each adjusted bearing of the wind turbine can be formed as a constituent part of a component arrangement according to the invention having a pressure sensor for determining a preload of the bearing.

The wind turbine preferably comprises an operation monitoring system for identifying operational disruptions, wherein in particular the operating monitoring system comprises an evaluation device for evaluating measurement signals of at least one pressure sensor of the component arrangement or is connected or can be connected to an evaluation device for evaluating measurement signals of the at least one pressure sensor of the component arrangement.

The object forming the basis of the invention is additionally achieved by a method for operating a wind turbine, in particular a previously described wind turbine according to the invention, having a component arrangement comprising an outer component, an inner component arranged within the outer component, and a rolling bearing pair, which has a first rolling bearing and a second rolling bearing arranged in a manner adjusted relative to one another and is preloaded by means of a clamping force, wherein the inner component and the outer component are mounted so as to be rotatable relative to one another by means of the rolling bearing pair, wherein the method comprises the following method steps:
determining an actual value for the preload of the rolling bearing pair, in particular by means of a pressure sensor arranged in a flow of the clamping force;
comparing the actual value with a predefined first reference range around a target value for the preload; and
interrupting the operation of the wind turbine when the actual value lies outside the reference range.

The method can be carried out in any operating modes of the wind turbine, in particular in full-load operation, in partial-load operation and in load-free operation and during downtime of the wind turbine. When it is determined here are that the preload of the rolling bearing pair lies outside the reference range, the operation of the wind turbine is interrupted in accordance with the invention and/or an alarm signal is sent to a remote monitoring center. This is understood to mean in particular that the wind turbine is transferred automatically or manually into a secured downtime mode. This can be caused for example by extremely low or extremely high external temperatures. The wind turbine is then released again for normal operation, in particular when a newly determined actual value for the preload of the rolling bearing pair, for example following adaptation of the clamping force, lies within the reference range.

A particularly preferred method according to the invention is characterized in that the actual value for the preload is compared with a second reference range around the target value for the preload, which in particular is a sub-range of the first reference range, wherein the clamping force is adapted during a subsequent, in particular routinely occurring, operation interruption of the wind turbine, when the actual value lies outside the second reference range.

It is thus made possible, even with small deviations of the actual value for the preload from the target value, to schedule in the adaptation of the clamping force, which can then be performed during routine maintenance of the wind turbine. An operation interruption specifically for the adaptation of the clamping force is thus avoided. The second reference range is therefore in particular to be measured so narrowly around the target value that the rolling bearing pair can continue to be operated without damage.

In accordance with an advantageous development of the invention the reference range is determined in accordance with a temperature. It is thus made possible advantageously to compensate for the considerable temperature-induced longitudinal extension in the case of large components and therefore to observe narrower tolerances of the reference range. The temperature here is preferably the temperature measured in the machine nacelle or in the transmission.

The method according to the invention for operating a wind turbine is preferably further developed such that the operating loads of the bearing are recorded. By means of an evaluation, known in the prior art, of the recorded operating loads, in particular in the form of load collectives, a prognosis of the anticipated remaining service life of the bearings is thus possible.

Further features of the invention will become clear from the description of embodiments according to the invention together with the claims and the accompanying drawings. Embodiments according to the invention may satisfy individual features or a combination of a number of features.

### BRIEF DESCRIPTION OF THE DRAWINGS

The invention will be described hereinafter without limitation of the general inventive concept on the basis of exemplary embodiments with reference to the drawings, wherein reference is made expressly to the drawings with regard to all details according to the invention not explained in greater detail in the text. In the drawings:

FIG. 1 schematically shows a typical power train of a wind turbine,

FIG. 2 schematically shows a bearing arrangement according to the invention in longitudinal axial sectional illustration,

FIG. 3 schematically shows the bearing arrangement according to the invention from FIG. 2 in a transverse axial sectional illustration, and

FIG. 4 schematically shows a sectional illustration of a transmission according to the invention of a wind turbine according to the invention.

In the drawings, like or equivalent elements and/or parts are provided in each case with the same reference numerals, such that there is no need for a renewed presentation in each case.

### DETAILED DESCRIPTION OF THE INVENTION

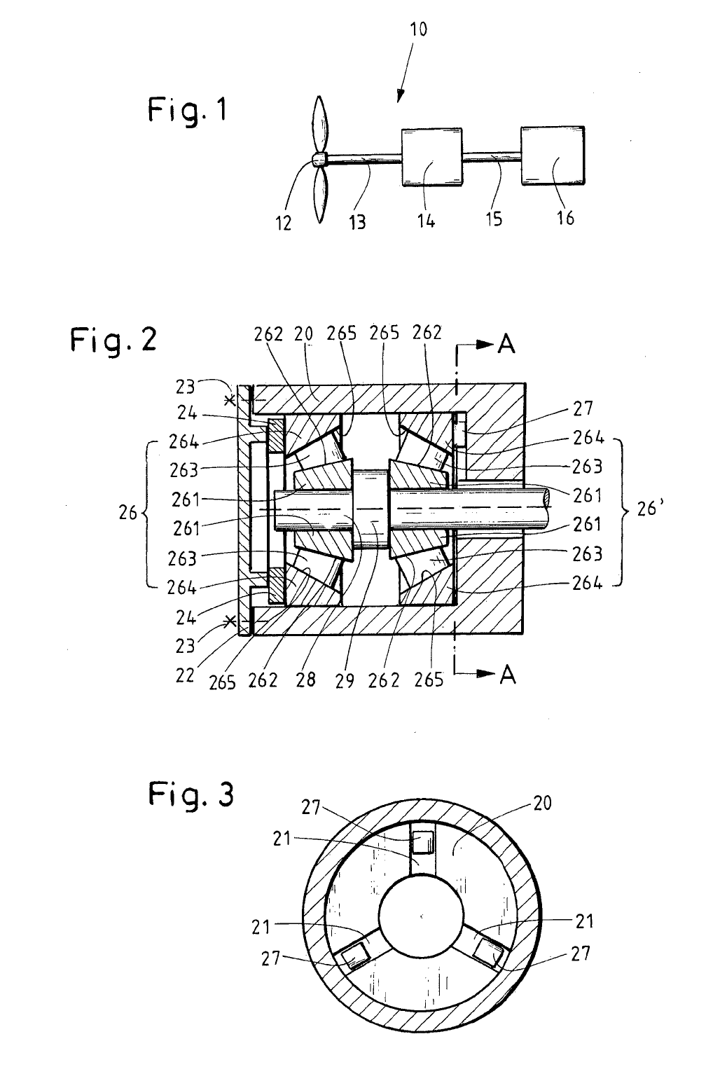

FIG. 1 schematically shows a typical power train 10 of a wind turbine. The power train 10 comprises a rotor 12 having a rotor hub and at least one rotor blade, which is rotated by wind power. The rotation of the rotor 12 is transmitted via a rotor shaft 13 to a transmission 14. The transmission 14 is connected on the output side via a transmission shaft 15 to a generator 16, which converts the mechanical energy removed from the wind by means of the rotor 12 into electrical energy. In contrast from the embodiment illustrated in FIG. 1, the invention can also be used in rolling bearings of wind turbines without transmission.

The transmission 14 is usually formed in such a way that the speed of rotation of the transmission shaft 15 is greater than the speed of rotation of the rotor shaft 13. Accordingly, the rotor shaft 13 is often also referred to as the slow shaft, and the generator shaft 15 is often also referred to as the quick shaft.

Further constituent parts of a typical power train 10, in particular clutches and brakes, are not illustrated in FIG. 1.

The rotating or rotatable elements of the power train, in particular the rotor shaft 13, the generator shaft 15 and also rotating or rotatable components within the transmission 14 and within the generator 16, are suitably mounted. Adjusted bearings having two rolling bearings preloaded against one another are generally used for this purpose, wherein at least one of these bearings in a wind turbine according to the invention is provided as a constituent part of a component arrangement according to the invention.

An example of a component arrangement according to the invention is shown schematically in FIG. 2 and FIG. 3. Here, FIG. 2 shows a longitudinal axial sectional illustration and FIG. 3 shows a transverse axial sectional illustration in the plane of section A-A indicated in FIG. 2.

The component arrangement comprises a shaft 28, which is mounted concentrically and rotatably within a housing 20. The corresponding axis of rotation is illustrated in FIG. 2 as a dashed line. The component arrangement also comprises a rolling bearing pair formed of two rolling bearings 26, 26′ formed as tapered-roller bearings, which each have an inner ring 261 resting against the shaft 28 and an outer ring 264 resting against the housing 20. The rolling bearings 26, 26′ each comprise conical rolling elements 263, which each roll over an outer bearing surface 265 of an outer ring 264 and over an inner bearing surface 262 of an inner ring 261.

In the axial direction the outer ring 264 of one rolling bearing 26′ rests on a total of three pressure sensors 27, which in this example are arranged in recesses 21 on a transverse axial rear wall of the housing 20. In the case of thin sensors, these are arranged directly on the housing rear wall. The inner ring 261 of the same rolling bearing 26′ rests against a stop 29 on the shaft 28 in the opposite direction.

The inner ring 261 of the other rolling bearing 26, which is arranged mirror-symmetrically with respect to the rolling bearing 26′, likewise rests against the stop 29 in the axial direction.

On the side opposite the housing rear wall, the housing 20 is closed by means of a housing cover 22 fastened via screw connections 23 to the housing 20. A spacer ring 24, which is adapted in terms of the thickness thereof, i.e. in the longitudinal axial extension thereof, in such a way that the two rolling bearings 26, 26′ and the shaft 28 are preloaded or clamped in the axial direction by means of a predefined clamping force between the rear wall of the housing 20 and the housing cover 22, is located between the housing cover 22 and the outer ring 264 of the rolling bearing 26.

A flow of clamping force is thus created running from the housing cover 22 via the spacer ring 24, the outer ring 264, the rolling elements 263 and also the inner ring 261 of the rolling bearing 26, the stop 29 of the shaft 28, the inner ring 261, the rolling elements 263 and also the outer ring 264 of the left rolling bearing, and the pressure sensors 27 as far as the rear wall of the housing 20 and is supported there, whereby in particular the housing 20 and the screw connections 23 of the housing cover 22 are tensile loaded in the axial direction.

The inner rings 261, rolling elements 263 and outer rings 264 of the rolling bearings 26, 26′ are pressed against one another by means of the clamping force to give an overall height reduction, whereby the rolling bearings 26, 26′ are preloaded. This preload can be measured or can be determined here by means of the pressure sensors 27, which are arranged in accordance with the invention likewise in the flow of the clamping force.

Ideally, radial components of the preload occurring by deflection of the clamping force within the rolling bearings 26, 26′ are symmetrical and cancel one another out accordingly. The rolling bearings 26, 26′ under preload, in particular with application of the clamping force, are thus oriented parallel to one another and concentrically with the axis of rotation.

However, in reality, asymmetric radial components of the preload also occur, in particular on account of gravitational or weight forces. This is regularly the case for example with a rotor shaft 13 on account of the high weight of the rotor 12.

So as to be able to identify or determine an asymmetric radial component of the preload, three pressure sensors 27 are provided, which are arranged along a circle about the axis of rotation at equal distance from one another, as illustrated in FIG. 3.

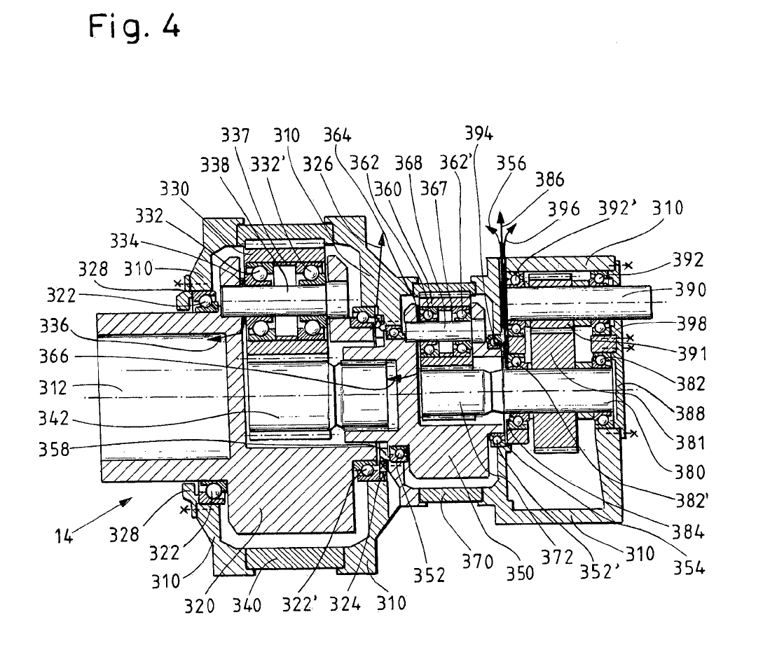

FIG. 4 shows a transmission 14 designed in accordance with the invention for a power train 10 of a wind turbine. The figure shows a sectional illustration, wherein components that visibly cut the plane of section of the illustration a number of times are provided in part with just one reference sign for reasons of clarity.

The transmission 14 shown by way of example has, on the input side, a shaft mount 312 for a rotor shaft 13 and has, on the output side, an output shaft 390, which is connected or can be connected to a generator 16.

The transmission 14 is formed in three stages with a first planetary gear stage, a second planetary gear stage and a spur gear stage. The three stages of the transmission 14 are formed in such a way that the speed of rotation is increased incrementally, such that the speed of rotation of the output shaft 390, which is also referred to as the quick shaft, is much higher than the speed of rotation of the rotor shaft 13, which is also referred to as the slow shaft.

The first planetary gear stage comprises a planet carrier 320 with the shaft mount 312 and at least one planet gear 330 arranged rotatably on the planet carrier 320, a stationary ring gear 340 integrated in a housing 310 of the transmission 14, and also a sun gear 342. The planet gear 330 runs around between the ring gear 340 and the sun gear 342, wherein the planet gear 330, the ring gear 340, and the sun gear 342 each have toothings meshing with one another.

The planet gear 330 is fastened by means of an axle pin 338 in a corresponding mount of the planet carrier 320 and is mounted rotatably about the axle pin 338 by means of two rolling bearings 332, 332′ formed as angular-contact ball bearings. The rolling bearings 332, 332′ form an adjusted bearing in what is known as an O-arrangement.

The planet gear 330 is formed as an internally mounted gearwheel, against which the outer rings of the rolling bearings 332, 332′ rest, wherein a spacer ring 337 is arranged between the outer rings. Alternatively, the outer rings of the rolling bearings 332, 332′ can be radially pressed into the planet gear 330 and thus connected to the planet gear 330 for conjoint rotation therewith and in a manner secured against slip. The inner rings of the rolling bearings 332, 332′ are arranged on the axle pin 338. Alternatively, the inner or outer ring can be omitted in the case of integrated bearing races.

The axle pin 338 has a pin head, on which the inner ring of the rolling bearing 332′ is supported axially. On the opposite side, the axle pin 338 is pressed into an opening in the planet carrier 320 in such a way that the rolling bearings 332, 332′ are preloaded between the pin head of the axle pin 338 and the planet carrier 320. The pin head is arranged in a bore of the planet carrier 320 and is accordingly supported radially. A tilting of the planet gear 330 relative to the planet carrier 320 is thus prevented.

Pressure sensors 334 formed as thin-film sensors for determining the preload of the rolling bearings 332, 332′ are arranged between the planet carrier 320 and the inner ring of the rolling bearing 332. For operation and readout of the pressure sensors 334, a sensor cabling 336 is provided. This is guided through the planet carrier 320 to the shaft mount 312.

By way of example, for assembly of the planet gear 330, the pressure sensors 334 are first arranged on the planet carrier, the sensor cabling 336 is installed as far as the shaft mount 312, and an evaluation device for the pressure sensors 334 is temporarily connected to the sensor cabling 336. The pressure sensors 334 are preferably already calibrated and are therefore ready for use during the ongoing assembly.

The planet gear 330 is then arranged with the two rolling bearings 332, 332′ on the planet carrier 320, and the axle pin 338 is pressed into the corresponding mount. The preload of the rolling bearings 332, 332′ is determined or established by means of the pressure sensors 334 and the evaluation device, and the axle pin 338 is pressed into the mount on the planet carrier 320 until the desired preload is reached. The determination of the preload and the pressing in of the axle pin 338 can be performed here simultaneously or in turn.

By way of example the evaluation device is then separated from the sensor cabling 336, and suitable means are installed in order to ensure, via the sensor cabling 336 at the shaft mount 312, which rotates in the transmission used as intended, the operation and the readout of the pressure sensors 334, also during operation of the transmission 14. Means suitable for this purpose are, for example, slip rings or induction loops.

The planet carrier 320 with the planet gear 330 mounted thereon is mounted rotatably within the housing 310 by means of two rolling bearings 322, 322′ formed as angular-contact ball bearings. The rolling bearings 322, 322′ each have an inner ring arranged on the planet carrier 320 and an outer ring arranged on the housing 310, wherein the rolling bearings form an adjusted bearing in what is known as an X-arrangement.

The bearing of the planet carrier 320 or the two rolling bearings 322, 322′ is also preloaded. For this purpose, the outer ring of the rolling bearing 322 is acted on by a clamping force by means of a housing covered 328 screwed to the housing 310. In order to adapt the clamping force, gauge plates of suitable thickness for example can be provided between the housing cover 328 and the outer ring of one rolling bearing 322.

Pressure sensors 324 formed as thin-film sensors are provided between the other rolling bearing 322′ and the housing 310, by means of which pressure sensors the preload of the rolling bearings 322, 322′ can be determined. The pressure sensors 324 are arranged uniformly along the periphery of the outer ring of the rolling bearing 322′. In order to operate and read out the pressure sensors 324, a sensor cabling 326 is provided, which is guided through the housing 310. The sensor cabling 326 is freely accessible on the housing outer side and for example can be connected to an evaluation device (not illustrated).

The second planetary gear stage also has a planet carrier 350 with at least one planet gear 360, a stationary ring gear 370 and also a sun gear 372. The planet carrier 350 of the second planetary gear stage is connected here to the sun gear 342 of the first planetary gear stage for conjoint rotation therewith.

The second planetary gear stage is dimensioned slightly smaller than the first planetary gear stage on account of the higher speed of rotation and accordingly lower torques occurring, but otherwise is constructed similarly to the first planetary gear stage. With regard to the bearing of the individual components, reference is made expediently to the description in relation to the first planetary gear stage. The planet gear 360 is also assembled on the planet carrier 350 in a manner corresponding to the assembly of the planet gear 330 on the planet carrier 320.

The planetary gear stages are assembled in a preferred embodiment in particular in succession, starting with the second planetary gear stage. For this purpose, the housing 310 of the transmission 14 is first brought into a first assembly position, in which the axis of rotation of the planet carrier 350 of the second stage, illustrated in FIG. 4 as a dot-and-dash line, is oriented vertically, wherein the housing part for the planetary gear stage is arranged above, and the housing part for the spur gear stage is arranged below.

The pressure sensors 354 and the corresponding sensor cabling 356 are first installed, and an evaluation device is connected to the sensor cabling, such that the pressure sensors 354 are ready for operation during the running assembly.

The rolling bearing 352′, the pre-assembled planet carrier 350 with at least one planet gear 360, and also the rolling bearing 352 are now placed in the housing 310 one after the other.

Here, for example, the pressure sensors 354 are read out with each step, such that a calibration table for the pressure sensors 354 is created on the basis of the known masses of the respective components and of the accordingly known pressure exerted onto the pressure sensors 354 by the components resting on the pressure sensors 354.

With good linearity, i.e. with linear response behavior, and good homogeneity, i.e. high similarity in the response behavior compared with identical thin-film sensors, of the pressure sensors 354, an offset calibration may be sufficient, for example by means of a readout and evaluation of the installed, unloaded pressure sensors 354. With good linearity, but poor homogeneity, a two-point calibration is generally sufficient, for example by means of a readout of the unloaded pressure sensors 354 and a readout following placement of all previously described components.

Alternatively or additionally hereto, the pressure sensors 354 may also have been suitably calibrated beforehand, for example in a suitable test machine.

The bearing cover 358 is then screwed to the housing 310, and a clamping force is thus applied to the rolling bearings 352, 352′. The resulting preload of the rolling bearings is determined on the basis of the pressure sensors 354. Where appropriate, the clamping force is adapted, for example by means of gauge sheets or spacer rings between the bearing cover 358 and the outer ring of the rolling bearing 352, until the desired preload of the rolling bearings 352, 352′ is reached. Here, dynamic clamping means, for example hydraulically spreadable spacer rings, can also be used, such that the screw connection of the housing cover does not have to be opened and closed a number of times.

A further check for correct preload of the rolling bearings can be implemented for example by rotating the transmission 14 into the operating position, in which in particular the axis of rotation of the planet carrier 350 is oriented horizontally or substantially horizontally, and by determining the preload of the rolling bearings 352, 352′ with stationary and/or rotating planet carrier 350, again by means of the pressure sensors 354.

The first planetary gear stage is then assembled in the same way.

The spur gear stage comprises a spur gear 381 and a gearwheel 391, which each have a toothing meshing with one another. The spur gear 381 is connected via an intermediate shaft 380 to the sun gear 372 of the second planetary gear stage, whereas the gearwheel 391 is connected to the output shaft 390 of the transmission 14 for conjoint rotation therewith.

The intermediate shaft 380 is mounted rotatably within the housing 310 by means of an adjusted bearing having two rolling bearings 382, 382′ formed as angular-contact ball bearings. The rolling bearings 382, 382′ each have an inner ring arranged on the intermediate shaft 380 and an outer ring arranged on the housing 310 and form an adjusted bearing in what is known as an X-arrangement.

The rolling bearings 382, 382′ are preloaded by means of a housing cover 388 screwed to the housing 310, wherein the housing cover 388 acts on the outer ring of the rolling bearing 382 with a clamping force. Where appropriate, an insert plate of suitable thickness is provided between the housing cover 388 and the outer ring of the rolling bearing 382 in order to selectively predefine the clamping force.

One or more pressure sensors 384 formed as thin-film sensors for determining the preload of the rolling bearing pair 382, 382′ is/are located between the outer ring of the other rolling bearing 382′ and the housing 310. The pressure sensor or the pressure sensors 384 is/are operated and read out via a sensor cabling 386. The sensor cabling 386 is guided here through the housing 310 to the housing outer side. The sensor cabling 386 is freely accessible on the housing outer side and by way of example can be connected to an evaluation device (not illustrated).

The output shaft 390 is mounted rotatably within the housing 310, likewise by means of an adjusted bearing having two rolling bearings 392, 392′ formed as angular-contact ball bearings. The rolling bearings 392, 392′ each have an inner ring arranged on the output shaft 390 and an outer ring arranged on the housing 310.

A preload of the rolling bearings 392, 392′ is achieved by a housing cover 398 screwed to the housing 310, which housing cover acts on the outer ring of the rolling bearing 392 with a clamping force. One or more pressure sensors 394 formed as thin-film sensors for determining the preload of the rolling bearing pair 392, 392′ and/or the bearing of the output shaft 390 is/are located between the outer ring of the other rolling bearing 392′ and the housing 310.

The pressure sensor or the pressure sensors 394 is/are operated and read out via a sensor cabling 396. The sensor cabling 396 for the pressure sensor or the pressure sensors 398 is guided here through the housing 310. The sensor cabling 396 is freely accessible on the housing outer side and by way of example can be connected to an evaluation device (not illustrated).

The spur gear stage is preferably assembled in a second assembly position of the housing, in which the axes of rotation of the intermediate shaft 380 and the output shaft 390 are arranged vertically, wherein the housing part for the spur gear stage is arranged above, and the housing part for the planetary gear stage is arranged below. Here, the spur gear stage can be assembled both before and after the assembly of the planetary gear stages.

The assembly of the intermediate shaft 380, the rolling bearings 382, 382′, the pressure sensors 384, the sensor cabling 386 and the housing cover 388 and also the assembly of the output shaft 390, the rolling bearings 392, 392′, the pressure sensors 394, the sensor cabling 396 and the housing cover 398 is performed in each case in accordance with the described assembly of the planet carrier 350, the rolling bearings 352, 352′, the pressure sensors 354, the sensor cabling 356 and the housing cover 358.

All specified features, including those to be inferred from the drawings alone and also individual features that are disclosed in combination with other features, are considered to be essential to the invention alone and in combination. Embodiments according to the invention can be satisfied by individual features or a combination of a number of features.

### LIST OF REFERENCE NUMBERS

10 power train

12 rotor

13 rotor shaft

14 transmission

15 quick shaft

16 generator

20 housing

21 recess

22 housing cover

23 screw connection

24 spacer ring

26, 26′ tapered roller bearing

261 inner ring

262 inner bearing surface

263 conical rolling element

264 outer ring

265 outer bearing surface

27 pressure sensor

28 shaft

29 stop

310 housing

312 shaft mount

320 planet carrier

322, 322′ rolling bearing

324 thin-film sensor

326 sensor cabling

328 housing cover

330 planet gear

332, 332′ rolling bearing

334 thin-film sensor

336 sensor cabling

337 spacer ring

338 axle pin

340 ring gear

342 sun gear

350 planet carrier

352, 352′ rolling bearing

354 thin-film sensor

356 sensor cabling

358 housing cover

360 planet gear

362, 362′ rolling bearing

364 thin-film sensor

366 sensor cabling

367 spacer ring

368 axle pin

370 ring gear

372 sun gear

380 intermediate shaft

381 spur gear

382, 382′ rolling bearing

384 thin-film sensor

386 sensor cabling

388 housing cover

390 output shaft

391 gearwheel

392, 392′ rolling bearing

394 thin-film sensor

396 sensor cabling

398 housing cover

What is claimed is:

1. A component arrangement for a wind turbine comprising:
an outer component;
an inner component arranged within the outer component; and
a rolling bearing pair, which has a first rolling bearing and a second rolling bearing arranged in a manner adjusted relative to one another and which is preloaded by means of a predefined clamping force;
wherein the inner component and the outer component are mounted so as to be rotatable relative to one another about an axis of rotation by means of the rolling bearing pair, and
wherein the component arrangement also comprises a pressure sensor for determining a preload of the rolling bearing pair, said pressure sensor being arranged in a flow of the clamping force.

2. The component arrangement as claimed in claim 1, wherein the component arrangement comprises, for preloading the rolling bearing pair by means of the predefined clamping force, at least one of a first clamping device acting on the first rolling bearing and a second clamping device acting on the second rolling bearing.

3. The component arrangement as claimed in claim 2, wherein the pressure sensor is arranged on a side of a rolling bearing facing away from the at least one of the first clamping device and the second clamping device.

4. The component arrangement as claimed in claim 1, wherein the pressure sensor is formed as a thin-film sensor.

5. The component arrangement as claimed in claim 4, wherein the thin-film sensor is a piezo-electric or piezo-resistive sensor layer.

6. The component arrangement as claimed in claim 4, wherein the thin-film sensor is formed as an independent component.

7. The component arrangement as claimed in claim 6, wherein the thin-film sensor is a layer carrier for the sensor layer independent of other constituent parts of the component arrangement.

8. The component arrangement as claimed in claim 1, wherein the component arrangement has an evaluation device for evaluating measurement signals of the pressure sensor.

9. The component arrangement as claimed in claim 1, wherein the component arrangement has at least a first pressure sensor arranged at the first rolling bearing and a second pressure sensor arranged at the second rolling bearing.

10. The component arrangement as claimed in claim 1, wherein the component arrangement comprises at least three pressure sensors

11. The component arrangement as claimed in claim 10, wherein the at least three pressure sensors are arranged in a plane oriented transversely to the axis of rotation.

12. The component arrangement as claimed in claim 1, wherein the component arrangement is formed as a constituent part for a power train of the wind turbine.

13. The component arrangement as claimed in claim 1, wherein the component arrangement is formed as a rotor bearing, as a transmission, as a generator, as part of a rotor bearing, as part of a transmission, or as part of a generator.

14. A method for assembling a component arrangement as claimed in claim 1, said method comprising:
calibrating at least one pressure sensor of the component arrangement;
preloading the rolling bearing pair of the component arrangement with a predefined clamping force;
determining an actual value for a preload of the rolling bearing pair by means of the at least one pressure sensor;
comparing the actual value with a predefined tolerance range around a target value for the preload; and
if the actual value lies outside the tolerance range, adjusting the clamping force.

15. The method as claimed in claim 14, wherein the at least one pressure sensor is calibrated in an assembly position of the component arrangement with vertically arranged axis of rotation without application of a clamping force with utilization of a known mass of the inner component and/or of the outer component and/or of one of the two rolling bearings and/or both rolling bearings.

16. A wind turbine comprising a component arrangement as claimed in claim 1.

17. The wind turbine as claimed in claim 16, wherein the wind turbine further comprises an operation monitoring system for identifying operational disruptions.

18. The wind turbine as claimed in claim 17, wherein the operating monitoring system comprises an evaluation device for evaluating measurement signals of at least one pressure sensor of the component arrangement or is connected to or connectable to an evaluation device for evaluating measurement signals of at least one pressure sensor of the component arrangement.

19. A method for operating a wind turbine according to claim 16, wherein the method comprises:
determining an actual value for the preload of the rolling bearing pair by means of the pressure sensor arranged in the flow of the clamping force;
comparing the actual value with a predefined first reference range around a target value for the preload; and
interrupting the operation of the wind turbine when the actual value lies outside the first reference range.

20. The method as claimed in claim 19, wherein the determined actual value for the preload is compared with a predefined second reference range around the target value for the preload, and wherein the clamping force is adjusted during a subsequent operation interruption of the wind turbine when the actual value lies outside the second reference range.

21. The method as claimed in claim 20, wherein the predefined second reference range is a sub-range of the first reference range.

22. The method as claimed in claim 20, wherein the subsequent operation interruption of the wind turbine is a routinely occurring operation interruption of the wind turbine.
